(19) United States
(12) Patent Application Publication
(10) Pub. No.: US 2023/0276237 A1
(43) Pub. Date: Aug. 31, 2023

(54) RESOURCE ISOLATION VIA ASSOCIATED IDENTIFIERS

(71) Applicant: Telefonaktiebolaget LM Ericsson (publ), Stockholm (SE)

(72) Inventors: George FOTI, Dollard Des Ormeaux (CA); Peter HEDMAN, Helsingborg (SE)

(21) Appl. No.: 18/007,334

(22) PCT Filed: Aug. 9, 2021
(86) PCT No.: PCT/IB2021/057331

§ 371 Date: Jan. 30, 2023

Related U.S. Application Data
(60) Provisional application No. 63/064,151, filed on Aug. 11, 2020.

(51) Int. Cl. H04W 12/086; H04W 12/06; H04W 60/06; H04W 76/34

(52) U.S. Cl. CPC H04W 12/086; H04W 12/06; H04W 60/06; H04W 76/34

(57) ABSTRACT

Apparatuses and methods for resource isolation via associated identifiers are disclosed. In one embodiment, a method implemented in a user equipment (UE) configured with a first identifier and a second identifier includes determining that resources and data associated with the first identifier require end-to-end isolation from the resources and data associated with the second identifier; transmitting a registration message to a network node comprising the first identifier; and if the UE has existing connections associated with the second identifier, releasing the existing connections associated with the second identifier to provide end-to-end isolation of the resources and data when the first identifier is transmitted in the registration message.

### TECHNICAL FIELD

The present disclosure relates to wireless communication and in particular, methods and apparatuses for resource isolation via associated identifiers.

### BACKGROUND

The Third Generation Partnership Project (3GPP) Technical Specification (TS) 23.501 and 3GPP TS 23.502 include the possibility to perform Network Slice-Specific Authentication and Authorization (NSSAA). The 3GPP 5^{th} Generation System (5GS) also allows the possibility to perform Secondary authentication/authorization during the establishment of a protocol data unit (PDU) Session.

One part of 3GPP Technical Report (TR) 23.700-40 addresses whether a network slice can be simultaneously used with other network slices for a user equipment (UE). The reasons for not allowing simultaneous use of some network slices is not described but may be assumed to be, e.g., security reasons, slice isolation, etc.

The possibility to create separate subscriptions for a UE, to use a dedicated subscription for the slices that require isolation, may be possible today by configuring a Universal Integrated Circuit Card (UICC) with more than one Universal Subscriber Identity Module (USIM) or by allowing more than one UICC in the UE. A UICC can be, for example, a traditional separate card, or embedded in a chip in the UE device, such as an embedded UICC (eUICC) or embedded SIM (eSIM), or integrated into a chip (e.g., iUICC). The user may then select which subscription out of the separate subscriptions to use by selecting the UICC application (i.e., USIM) to use via a user interface in the UE.

The industry is also developing Trusted Execution Environments (TEE) and Tamper Resistant Environments (TRE) that enables secure areas in a UE (e.g., a Mobile Entity (ME)) without the need for a UICC.

5GS and Network Slicing may allow multiple user identities (IDs) and credentials to be used by a UE at the same time e.g., Subscription Permanent Identifier (SUPI) and Authentication and Key Agreement (AKA)-credentials used at Primary authentication procedure and then a separate Extension Authentication Protocol (EAP)-identity (EAP-ID) and credentials used during Secondary authentication or Network Slice-Specific Authentication and Authorization (NSSAA). The SUPI and AKA is stored in the UICC at the UE; however, it is not well-defined where the separate identities (IDs) and credentials for NSSAA and Secondary authentication are stored.

To enable Network Slice selection, 3GPP has specified different information as described, for example, in 3GPP TS 23.501, TS 23.502 and TS 24.501 e.g., Single/Selected-Network Slice Selection Assistance Information (S-NSSAI), Requested Network Slice Selection Assistance Information (NSSAI), Configured NSSAI, Allowed NSSAI, etc.

### SUMMARY

Some embodiments advantageously provide methods and apparatuses for network slice isolation with user/UE profiles via associated identifiers.

In one embodiment, a method implemented in a user equipment (UE) includes using a at least one associated identifier, each associated identifier being associated with a respective isolated set of single-network slice selection assistance information (S-NSSAI).

In one embodiment, a method implemented in an access and mobility management function (AMF) node includes using at least one associated identifier, each associated identifier being associated with a respective isolated set of single-network slice selection assistance information (S-NSSAI).

In one embodiment, a method implemented in a unified data management (UDM) node includes receiving a request to retrieve subscription data for a user equipment (UE) during a registration procedure of the UE to a network; and sending the subscription data to an access and mobility function (AMF) node as a result of the request, the subscription data comprising at least one associated identifier, each associated identifier being associated with a respective isolated set of single-network slice selection assistance information (S-NSSAI).

According to an aspect of the present disclosure, a method implemented in a user equipment, UE, configured to communicate with a network node is provided. The method comprises receiving a first associated identifier and a second associated identifier; determining that a first set of network slices requires isolation based on an association of the first associated identifier to information identifying the first set of network slices; determining that a second set of network slices requires isolation based on an association of the second associated identifier to information identifying the second set of network slices; transmitting a registration message comprising the first associated identifier to the network node; and as a result of the transmitted registration message, terminating all protocol data unit, PDU, sessions associated with the second associated identifier to provide the required isolation of the first set of network slices from at least the second set of network slices when the first associated identifier is comprised in the registration message.

In some embodiments of this aspect, the information identifying the first set of network slices comprises a first set of network slice selection assistance information, NSSAI; and the information identifying the second set of network slices comprises a second set of NSSAI. In some embodiments of this aspect, receiving the first and second associated identifiers in one of a registration accept message and a UE configuration update message from the network node. In some embodiments of this aspect, transmitting the registration message comprising the first associated identifier further comprises selecting the first associated identifier and initiating a slice switching registration using the selected first associated identifier. In some embodiments of this aspect, further comprising: as a result of the slice switching registration, receiving a second globally unique temporary identifier, 5G-GUTI, the second 5G-GUTI overwriting a current 5G-GUTI.

In some embodiments of this aspect, the slice switching registration comprises switching from the second set of network slices that is currently used at the UE to the first set of network slices that is associated with the first associated identifier comprised in the registration message. In some embodiments of this aspect, the first associated identifier in the registration message implicitly indicates to tear down all the PDU sessions associated with the second associated identifier. In some embodiments of this aspect, the first associated identifier comprises a subscription permanent identifier, SUPI, and a Global Public Subscriber Identifier, GPSI, per network slice in the first set of network slices.

In some embodiments of this aspect, further comprising: storing security information and an extensible authentication protocol identity, EAP-ID, at the UE; receiving a request to perform a network slice-specific authentication and authorization, NSSAA, procedure for a first network slice in the first set of network slices; and as a result of the request to perform the NSSAA procedure, using the GPSI that is associated with the first network slice as a key to identify the stored security information and the EAP-ID to use in the NSSAA procedure for the first network slice.

According to yet another aspect of the present disclosure, a method implemented in a user equipment, UE, configured with a first identifier and a second identifier is provided. The method comprises determining that resources and data associated with the first identifier require end-to-end isolation from the resources and data associated with the second identifier; transmitting a registration message to a network node comprising the first identifier; and if the UE has existing connections associated with the second identifier, releasing the existing connections associated with the second identifier to provide end-to-end isolation of the resources and data when the first identifier is transmitted in the registration message.

In some embodiments of this aspect, the first identifier and the second identifier correspond to a first and a second slice identifier. In some embodiments of this aspect, the first identifier and the second identifier correspond to a first and a second vertical identifier. In some embodiments of this aspect, the first identifier and the second identifier correspond to a first and a second Subscription Permanent Identifier, SUPI, or Global Public Subscriber Identifier, GPSI.

In some embodiments of this aspect, the resources associated with the first identifier correspond to at least one of a first memory space, a first processing resource and a first network resource and the resources associated with the second identifier correspond to at least one of a second memory space, a second processing resource and a second network resource, the resources associated with the first identifier being isolated from the resources associated with the second identifier.

According to another aspect of the present disclosure, a method implemented in a network node is provided. The method comprises sending a first associated identifier and a second associated identifier to a user equipment, UE, the first associated identifier being associated with information identifying a first set of network slices that requires isolation and the second associated identifier being associated with information identifying a second set of network slices that requires isolation; receiving a registration message comprising the first associated identifier from the UE; and as a result of the received registration message, terminating all protocol data unit, PDU, sessions associated with the second associated identifier to provide the required isolation of the first set of network slices from at least the second set of network slices when the first associated identifier is comprised in the registration message.

In some embodiments of this aspect, the information identifying the first set of network slices comprises a first set of network slice selection assistance information, NSSAI; and the information identifying the second set of network slices comprises a second set of NSSAI. In some embodiments of this aspect, sending the first and second associated identifiers in one of a registration accept message and a UE configuration update message. In some embodiments of this aspect, the method further comprises as a result of the received the registration message comprising the first associated identifier, performing a slice switching registration using the first associated identifier.

In some embodiments of this aspect, the method further includes as a result of the slice switching registration, sending a second globally unique temporary identifier, 5G-GUTI, to the UE, the second 5G-GUTI overwriting a current 5G-GUTI at the UE. In some embodiments of this aspect, the slice switching registration comprises switching the UE from the second set of network slices to the first set of network slices that is associated with the first associated identifier comprised in the registration message. In some embodiments of this aspect, the first associated identifier in the registration message implicitly indicates to tear down all the PDU sessions associated with the second associated identifier. In some embodiments of this aspect, the first associated identifier comprises a subscription permanent identifier, SUPI, and a Global Public Subscriber Identifier, GPSI, per network slice in the first set of network slices.

In some embodiments of this aspect, the method further includes sending security information and an extensible authentication protocol identity, EAP-ID, to the UE, the GPSI that is associated with the first network slice being a key for the UE to identify the security information and the EAP-ID to use in a network slice-specific authentication and authorization, NSSAA, procedure for the first network slice.

According to another aspect of the present disclosure, a method implemented in a unified data management, UDM, node, is provided. The method comprises receiving a request to retrieve subscription data for a user equipment, UE, during a registration procedure of the UE to a network; and sending the subscription data to an access and mobility function, AMF, node as a result of the request, the subscription data comprising a first associated identifier and a second associated identifier, the first associated identifier being associated with information identifying a first set of network slices that requires isolation and the second associated identifier being associated with information identifying a second set of network slices that requires isolation.

In some embodiments of this aspect, the first and second associated identifiers comprise a subscription permanent identifier, SUPI, and a Global Public Subscriber Identifier, GPSI, per network slice in the respective set of network slices. In some embodiments of this aspect, the method further includes sending security information and an extensible authentication protocol identity, EAP-ID, to the AMF node, the GPSI being a key for the UE to identify the security information and the EAP-ID to use in a network slice-specific authentication and authorization, NSSAA, procedure for a network slice that is associated with the GPSI.

According to another aspect, a user equipment, UE, comprises processing circuitry. The processing circuitry is configured to cause the UE to perform any one or more of the methods above.

According to another aspect, a network node comprises processing circuitry. The processing circuitry is configured to cause the network node to perform any one or more of the methods above.

According to another aspect, a unified data management, UDM, node comprises processing circuitry. The processing circuitry is configured to cause the UDM node to perform any one or more of the methods above.

According to another aspect, a computer readable medium comprising instructions executable by a processor to perform any one or more of the methods of above is provided.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example system architecture according to some embodiments of the present disclosure;

FIG. 2 illustrates yet another example system architecture and example hardware arrangements for devices in the system, according to some embodiments of the present disclosure;

FIG. 3 is a flowchart of an example process in a user equipment according to some embodiments of the present disclosure;

FIG. 4 is a flowchart of an example process in a network node (e.g., AMF node) according to some embodiments of the present disclosure;

FIG. 5 is a flowchart of an example process in a network node (e.g., UDM node) according to some embodiments of the present disclosure;

FIG. 6 illustrates an example initial registration procedure e.g., of the UE to 5GS according to one embodiment of the present disclosure;

FIG. 7 illustrates an example initial registration procedure e.g., of the UE to 5GS according to one embodiment of the present disclosure;

FIG. 8 is a flowchart of an example process in a network node (e.g., AMF node) according to some embodiments of the present disclosure;

FIG. 9 is a flowchart of an example process in a network node (e.g., UDM node) according to some embodiments of the present disclosure;

FIG. 10 illustrates an example initial registration procedure e.g., of the UE to 5GS according to one embodiment of the present disclosure;

FIG. 11 illustrates an example slice switching registration procedure e.g., of the UE to 5GS according to one embodiment of the present disclosure; and

FIG. 12 illustrates an example UE comprising UICC applications and an ME that may be used to store the information described in the present disclosure.

### DETAILED DESCRIPTION

As discussed above, 5GS and Network Slicing may allow multiple user identities (IDs) and credentials to be used by a UE at the same time. However, there is currently no definition describing how the UE knows which EAP-ID to use for NSSAA. Further, the solutions considered in TR 23.700-40 does not address the issue of slice isolation in the UE. It is also not defined where the separate identities (IDs) and credentials for NSSAA and Secondary authentication are stored.

In some embodiments, such IDs and credentials may be stored in the USIM or in ME (e.g. TEE/TRE).

Some embodiments of the present disclosure provide that, in order to isolate the usage of different network slices by the UE, the UE may be allocated different identities (IDs) to use with S-NSSAIs that require isolation. The IDs may include or incorporate a Generic Public Subscription Identifier (GPSI). For example, the UE is allocated SUPI1/GPSI1 for S-NSSAI1 and SUPI2/GPSI2 for S-NSSAI2, if the network slices associated with S-NSSAI1 and S-NSSAI2 require isolation. In some embodiments, this may ensure that the UE does not use the S-NSSAIs requiring isolation simultaneously. Note that these sets of slices requiring isolation may have only a single slice per set, as in the above example (S-NSSA1, and S-NSSAI2), or may have more than a single slice per set. Each set may be allocated a single SUPI, but each S-NSSAI in the set may be allocated a different GPSI for Slice authentication and authorization purposes. As one illustrative example, in some embodiments, there may be provided:
Default SUPI associated with S-NSSAI1 (GPSI1) and S-NSSAI 2 (GPSI2);
Associated-Identifier SUPI1 associated with S-NSSAI3 (GPSI3) and S-NSSAI 4 (GPSI4); and
Associated-Identifier SUPI2 associated with S-NSSAI5 (GPSI5), S-NSSAI 6 (GPSI6) and S-NSSAI7 (GPSI7). In the example, the default SUPI for the first set has 2 slices, the Associated-Identifier for the second set has 2 slices and the Associated-Identifier for the third set has 3 slices. In some embodiments, these sets could also have a single S-NSSAI.

Although the example shows that all 3 sets of slices have distinct S-NSSAI in each set, in some embodiments, it may be possible to have one or more common S-NSSAI in more than one set. For example, eMBB (Mobile Broadband S-NSSAI eMBB) can be in more than one set in addition to the above.

Note also the following:
Default SUPI is the SUPI used in the main subscription in the UDM. It registers the entire profile (including Associated-Identifier), and deregisters the entire profile.
Each Associated Identifier may have a distinct SUPI for the set, and a GPSI per S-NSSAI in the slice set. The slices in the slice set are the Allowed slices for that SUPI.

In some embodiments, the same applies to the default SUPI when it comes to the Allowed slices in this case.

In some embodiments, slice switching registration enables switching between slice sets after the initial SUPI registration. This includes even the default SUPI only after it has been slice switched by another Associated-Identifier.

In some embodiments of this approach, several profiles may be created in how S-NSSAI slices are to be used.

In some embodiments, it may be required that each of the isolated sets of slices are isolated from one another such that e.g., only one set can be used at the UE simultaneously.

In some embodiments, an S-NSSAI can be associated to more than one ID (e.g., Associated-Identifier). For example, S-NSSAI-1 and S-NSSAI-2 may be required to be isolated from each other but both can be used with S-NSSAI-3.

In some embodiments, the network, e.g., a network node, may ensure that the UE profiles are created accordingly. Hence, there may be no need for real-time checking by the network. To support that, in some embodiments, the UE may be provisioned with a default user/UE profile, and may also be allocated an independent SUPI/GPSI for each S-NSSAI that has to be used independently (e.g., requires slice isolation between different network slices). These additional SUPI/GPSIs and the particular S-NSSAI that each is bound to may also be used to authenticate the UE if the S-NSSAI requires a Secondary authentication.

In some embodiments, these SUPI/GPSIs may be referred to interchangeably herein more generally as “associated-identifiers” or “associated-IDs”. After acquiring the associated-identifiers following initial UE registration (e.g., to the 5GS), when the UE determines to use a different network slice the UE may initiate a new type of UE registration for slice switching. This new slice-switching registration may use the same security association of the default SUPI. In some embodiments, the default SUPI is indicated in the default user profile.

The slice-switching registration may instruct the AMF to terminate all activity with the currently registered identifier (e.g., currently registered associated-ID) regarding the bound S-NSSAI for the registered identifier; meaning all PDU sessions using that S-NSSAI may be terminated. The new S-NSSAI associated with the registering associated-identifier will be the new Allowed S-NSSAI.

In some embodiments, only one SUPI can be registered at a time for the UE when a registration includes associated-identifiers.

In some embodiments, only the default SUPI deregistration deregisters the entire UE. In some embodiments, an associated-identifier cannot deregister the UE, except through a slice switching registration of another, different SUPI/GPSI, including default SUPI registration. Hence, the deregistration of any associated SUPI/GPSI is implicit by the registration of another SUPI/GPSI, and the AMF clears the PDU sessions associated with an implicitly deregistered SUPI/GPSI.

In some embodiments, when it comes to subscription data, all subscription data in the default user profile applies to every associated SUPI/GPSI included in the registration accept response.

In some embodiments, the UE will always initially register to the 5GS using the default SUPI.

In some embodiments, a slice-switching registration refreshes the default SUPI registration. In some embodiments, a regular (e.g., a registration not switching between slices associated with the default SUPI) default SUPI registration may equally refresh the registration regardless of the currently registered associated-identifier.

In some embodiments, to enable the UE to know/determine which user identity (EAP-IP) to use for NSSAA, the UE may be configured with the GPSI to be used for the NSSAA for an S-NSSAI. In addition, the UE may be configured with a reference to the security information to be used for the authentication during the NSSAA.

In some embodiment, the network slice selection function (NSSF) may be kept unaware of the network slice isolation by the AMF (e.g., network slice isolation may be transparent to the NSSF). In such embodiments, the AMF may provide a complete list of subscribed S-NSSAIs to the NSSF, e.g., for all identities default SUPI, and SUPI for associated identifiers. In some embodiments, the AMF derives the applicable subsets to be used for each identity out of the information provided by the NSSF, when it constructs the Allowed S-NSSAI and Configured NSSAI for the default SUPI, and for the associated identifiers in the Registration Accept Message (or in some embodiments, in a UE Configuration Update message from the AMF).

In some embodiments, the UE is configured to ensure there is no data, memory or any resource leak in the use of the set of NSSAIs associated with each identity. Hence, the use of each set of S-NSSAIs with an identity (e.g., first identity) may be kept (e.g., by the UE) completely contained, controlled and decoupled (e.g., at the UE) from any other set of S-NSSAIs having a different identity (e.g., second identity).

In some embodiments, the network also provides similar isolation properties at the network resource level. By ensuring isolation as between sets of NSSAIs having different identities, both at the UE level and the network resource level, privacy and confidentiality may be ensured and maintained end-to-end for a set of S-NSSAIs/NSSAIs associated with a particular identity (e.g., associated identity).

Even though some embodiments of the present disclosure use S-NSSAI/NSSAI to identify a network slice and the associated resources and data for end-to-end isolation as described above, there are cases when resources and data also require end-to-end isolation as between different sets associated with different identities, but not tied to network slices or network slice identifiers; and instead being tied to other identifiers that can be used to enable an association with resources and data. An example may be when a shared resource is dynamically shared between multiple verticals, but for each vertical complete end-to-end isolation is required. Here, a vertical identifier (ID) could be used to identify the allocated resources end-to-end.

In some embodiments, the resources may be specific for an amount of resources e.g., amount of memory space and processing capabilities at the UE.

Although some examples and some embodiments are described in a UE registration context, it should be understood that the information and the identifiers discussed herein (e.g., identifiers, vertical identifiers, GUTI, associated identifiers, allowed NSSAI, configured NSSAI, etc.) may be provided in a UE Configuration Update message (instead of the Registration Accept message, in some embodiments). The UE Configuration Update message may be transmitted by the AMF during a UE Configuration Update procedure initiated by the AMF. The UE Configuration Update procedure may allow the AMF to update the UE with access and mobility-related parameters (e.g., without necessarily having to request the UE to perform a registration procedure).

In some embodiments, it may be considered that the UE has a main subscription with the UDM using the default SUPI. It may be that each slice may itself be identified by a S-NSSAI/NSSAI. The other associated identifiers may be used for using slices that require isolation (i.e., isolated set of S-NSSAI). The main subscription with the default SUPI may also have its own slices that require isolation from the slices included in the associated identifiers.

Some embodiments of the present disclosure enable the possibility for the user to select a profile (GPSI) for which the user wants to use and be available, which then can result in which network slices the UE and user can use as a consequence.

Some embodiments of the present disclosure may provide an efficient, simple and well-defined isolation arrangement and/or provide knowledge of which network slices can and/or cannot be used at the same time for a UE.

Some embodiments of the present disclosure may provide for an efficient, simple and well-defined association of NSSAA and secondary authentication and the related user identities and credentials to use.

Before describing in detail exemplary embodiments, it is noted that the embodiments reside primarily in combinations of apparatus components and processing steps related to resource isolation via associated identifiers. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

In some embodiments, the non-limiting terms wireless device (WD) or a user equipment (UE) are used interchangeably. The UE herein can be any type of wireless device capable of communicating with a network node or another UE over radio signals. In some embodiments, the UE may be or include a mobile entity (ME). The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, integrated access and backhaul (IAB), donor node controlling relay, radio access point (AP), transmission points, transmission nodes, Remote Radio Unit (RRU) Remote Radio Head (RRH), a core network node (e.g., an Access and Mobility Function (AMF), a Unified Data Management (UDM) function or Home Subscriber Server (HSS), mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the term “node” is used herein and can be any kind of network node, such as, an AMF node, a UDM node, etc.

A node may include physical components, such as processors, allocated processing elements, or other computing hardware, computer memory, communication interfaces, and other supporting computing hardware. The node may use dedicated physical components, or the node may be allocated use of the physical components of another device, such as a computing device or resources of a datacenter, in which case the node is said to be virtualized. A node may be associated with multiple physical components that may be located either in one location, or may be distributed across multiple locations.

In some embodiments, the term “set” is used and may indicate 1 slice or more than 1 slices within the set. In some embodiments, there can be more than one S-NSSAI in a set, there may be a single SUPI for this set, but there may be a separate GPSI per each S-NSSAI for slice authorization

In some embodiments, the terms “identifier”, “associated identifier” or “separate identifier” may be used interchangeably with the terms “associated-identifier”, “Associated-Identifier”, “associated-ID” and/or “SUPI/GPSI”. In some embodiments, such identifiers are included in a default user/UE profile that is e.g., retrieved from a UDM node. In some embodiments, such identifier or at least a part of the identifier (e.g., GPSI, NSSAA-GPSI) may be considered as, used as, used to derive and/or related to an EAP-ID to use for an NSSAA procedure. In some embodiments, these identifiers are used for NSSAA.

In some embodiments, each associated identifier that is associated with a respective set of isolated S-NSSAI includes one or more of: an associated identifier subscription permanent identifier (SUPI) associated with the UE and/or a generic public subscription identifier (GPSI). In some embodiments, for an associated identifier, there may always be one SUPI and where the one SUPI may associated with different GPSIs. In some embodiments, this may provide a novel and efficient identification arrangement that may facilitate the UE ensuring that the S-NSSAIs requiring isolation are not used (e.g., by the UE) simultaneously.

In some embodiments, the term “pre-configured” may refer to the related information being defined for example in a standard, and/or being available, e.g. stored in memory at the node that is pre-configuration with the related information.

Any two or more embodiments described in this disclosure may be combined in any way with each other.

Note also that some embodiments of the present disclosure may be supported by standard documents disclosed in Third Generation Partnership Project (3GPP) technical specifications. That is, some embodiments of the description can be supported by the above documents. In addition, all the terms disclosed in the present document may be described by the above standard documents.

Note that although terminology from one particular wireless system, such as, for example, 3^{rd} Generation Partnership Project (3GPP), Long Term Evolution (LTE), 5^{th} Generation (5G) (also known as New Radio (NR)), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a UE, AMF node, UDM node or any network node may be distributed over a plurality of UEs, a plurality of AMF nodes, a plurality of UDM nodes or a plurality of network nodes. In other words, it is contemplated that the functions of the UE, AMF node, UDM node or network node described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

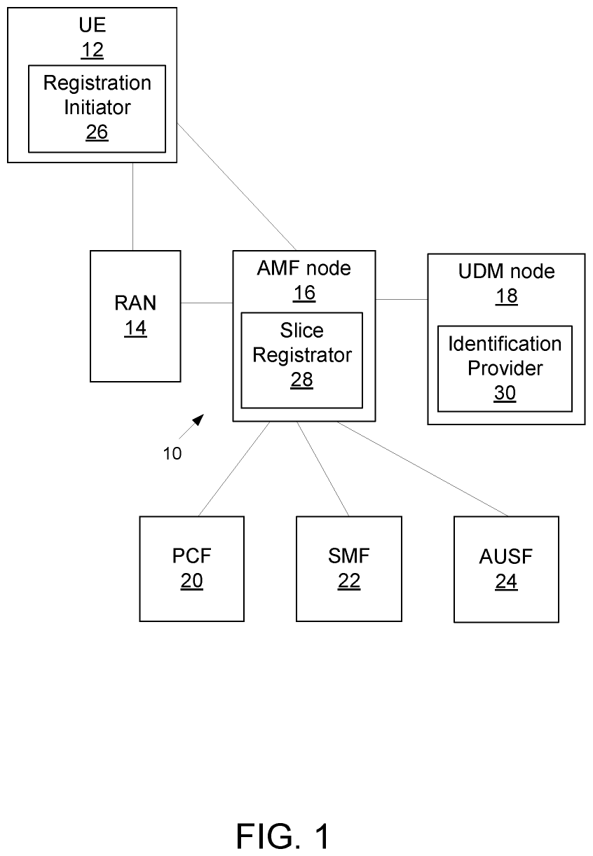

Referring now to the drawing figures, in which like elements are referred to by like reference numerals, there is shown in FIG. 1 a schematic diagram of the communication system 10, according to an embodiment, constructed in accordance with the principles of the present disclosure. The communication system 10 in FIG. 1 is a non-limiting example and other embodiments of the present disclosure may be implemented by one or more other systems and/or networks. Referring to FIG. 1, the system 10 includes a UE 12, a radio access network (RAN) 14 (e.g., 3GPP 5^{th} Generation (5G) RAN also known as New Radio or NR RAN), which may provide radio access to the UE 12. The system 10 includes an Access and Mobility Management Function (AMF) node 16, which may provide a function for access and/or mobility management for the UE 12. The system 10 includes a UDM node 18, which stores and manages subscriber information. The system 10 further includes a policy charging function (PCF) 20, a session management function (SMF) 22 and an authentication server function (AUSF) 24. The PCF 20 may provide services related to policy rules and/or enforcement. The SMF 22 may handle session management for the UE 12. The AUSF 24 may provide authentication and encryption services. It should be noted that, for simplicity, a single node is shown for the various entities in the system 10 depicted in FIG. 1 (e.g., a single UE 12, a single RAN 14, a single AMF node 16, a single UDM node 18, etc.); however, it should be understood that the system 10 may include numerous entities/nodes of those shown in FIG. 1, as well as, additional entities/nodes not shown in FIG. 1. In addition, the system 10 may include many more connections than those shown in FIG. 1.

The UE 12 may include a registration initiator 26, which may be configured to cause the UE 12 to use at least one associated identifier, each associated identifier being associated with a respective isolated set of single-network slice selection assistance information (S-NSSAI).

The AMF node 16 may include a slice registrator 28, which is configured to cause the AMF node 16 to use at least one associated identifier, each associated identifier being associated with a respective isolated set of single-network slice selection assistance information (S-NSSAI).

The UDM node 18 may include an identification provider 30, which may be configured to cause the UDM node 18 to receive a request to retrieve subscription data for a user equipment (UE) during a registration procedure of the UE to a network; and send the subscription data to an access and mobility function (AMF) node as a result of the request, the subscription data comprising at least one associated identifier, each associated identifier being associated with a respective isolated set of single-network slice selection assistance information (S-NSSAI).

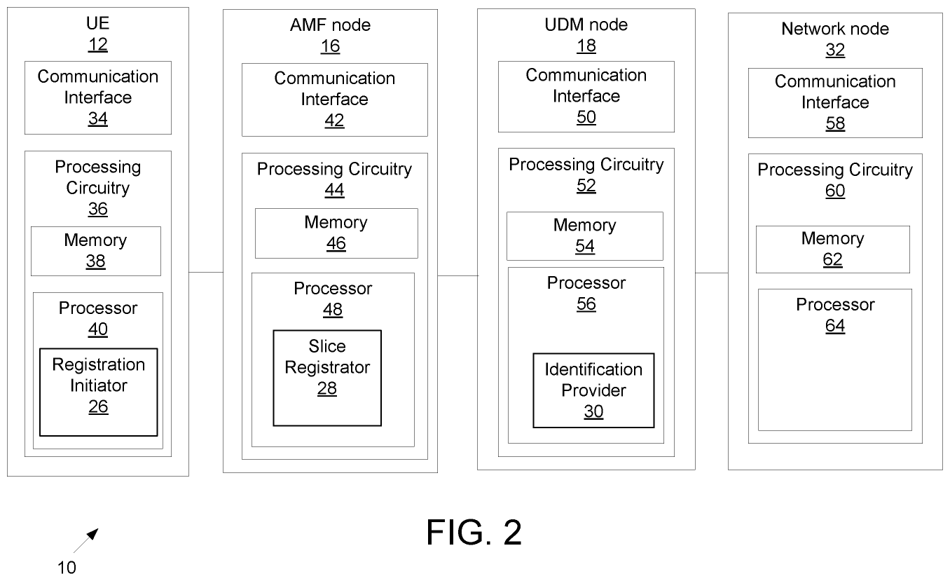

Example implementations, in accordance with an embodiment, of the UE 12, AMF node 16, UDM node 18 and a network node 32 discussed in the preceding paragraphs will now be described with reference to FIG. 2.

The UE 12 includes a communication interface 34, processing circuitry 36, and memory 38. The communication interface 34 may be formed as or may include, for example, one or more radio frequency (RF) transmitters, one or more RF receivers, and/or one or more RF transceivers, and/or may be considered a radio interface. In some embodiments, the communication interface 34 may also include a wired interface.

The processing circuitry 36 may include one or more processors 40 and memory, such as, the memory 38. In particular, in addition to a traditional processor and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 40 may be configured to access (e.g., write to and/or read from) the memory 38, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

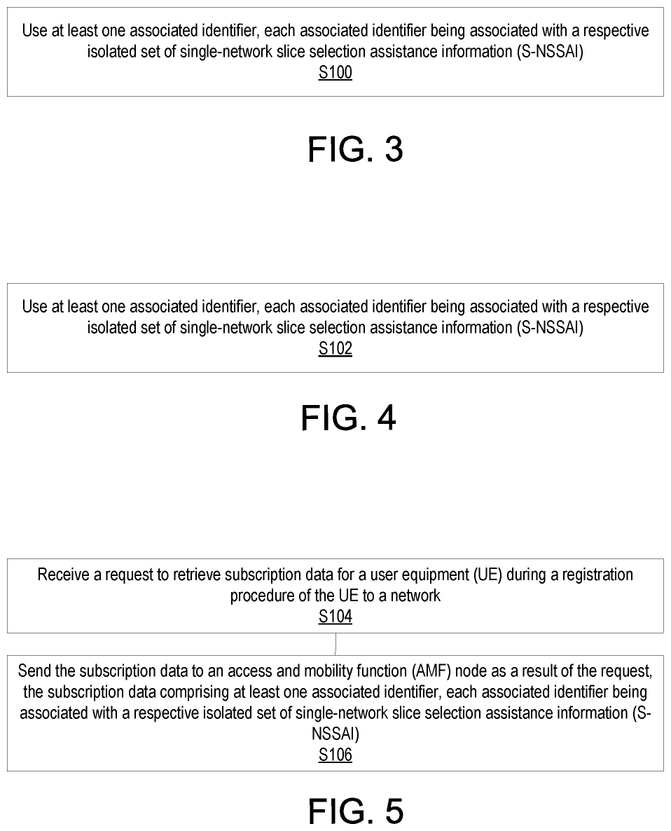

Thus, the UE 12 may further include software stored internally in, for example, memory 38, or stored in external memory (e.g., database) accessible by the UE 12 via an external connection. The software may be executable by the processing circuitry 36. The processing circuitry 36 may be configured to control any of the methods and/or processes described herein and/or to cause such methods, and/or processes to be performed, e.g., by the UE 12. The memory 38 is configured to store data, programmatic software code and/or other information described herein. In some embodiments, the software may include instructions stored in memory 38 that, when executed by the processor 40 and/or registration initiator 26 causes the processing circuitry 36 and/or configures the UE 12 to perform the processes described herein with respect to the UE 12 (e.g., processes described with reference to FIG. 3 and/or any of the other flowcharts).

The AMF node 16 includes a communication interface 42, processing circuitry 44, and memory 46. The communication interface 42 may be formed as or may include, for example, one or more radio frequency (RF) transmitters, one or more RF receivers, and/or one or more RF transceivers, and/or may be considered a radio interface. In some embodiments, the communication interface 42 may also include a wired interface.

The processing circuitry 44 may include one or more processors 48 and memory, such as, the memory 46. In particular, in addition to a traditional processor and memory, the processing circuitry 44 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 48 may be configured to access (e.g., write to and/or read from) the memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the AMF node 16 may further include software stored internally in, for example, memory 46, or stored in external memory (e.g., database) accessible by the AMF node 16 via an external connection. The software may be executable by the processing circuitry 44. The processing circuitry 44 may be configured to control any of the methods and/or processes described herein and/or to cause such methods, and/or processes to be performed, e.g., by the AMF node 16. The memory 46 is configured to store data, programmatic software code and/or other information described herein. In some embodiments, the software may include instructions stored in memory 46 that, when executed by the processor 48 and/or slice registrator 28, causes the processing circuitry 44 and/or configures the AMF node 16 to perform the processes described herein with respect to the AMF node 16 (e.g., processes described with reference to FIG. 4 and/or any of the other flowcharts).

The UDM node 18 includes a communication interface 50, processing circuitry 52, and memory 54. The communication interface 50 may be formed as or may include, for example, one or more radio frequency (RF) transmitters, one or more RF receivers, and/or one or more RF transceivers, and/or may be considered a radio interface. In some embodiments, the communication interface 50 may also include a wired interface.

The processing circuitry 52 may include one or more processors 56 and memory, such as, the memory 54. In particular, in addition to a traditional processor and memory, the processing circuitry 52 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 56 may be configured to access (e.g., write to and/or read from) the memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UDM node 18 may further include software stored internally in, for example, memory 54, or stored in external memory (e.g., database) accessible by the UDM node 18 via an external connection. The software may be executable by the processing circuitry 52. The processing circuitry 52 may be configured to control any of the methods and/or processes described herein and/or to cause such methods, and/or processes to be performed, e.g., by the UDM node 18. The memory 54 is configured to store data, programmatic software code and/or other information described herein. In some embodiments, the software may include instructions stored in memory 54 that, when executed by the processor 56 and/or identification provider 30, causes the processing circuitry 52 and/or configures the UDM node 18 to perform the processes described herein with respect to the UDM node 18 (e.g., processes described with reference to FIG. 5 and/or any of the other flowcharts).

The network node 32 (e.g., RAN, base station) includes a communication interface 58, processing circuitry 60, and memory 62. The communication interface 58 may be formed as or may include, for example, one or more radio frequency (RF) transmitters, one or more RF receivers, and/or one or more RF transceivers, and/or may be considered a radio interface. In some embodiments, the communication interface 58 may also include a wired interface.

The processing circuitry 60 may include one or more processors 64 and memory, such as, the memory 62. In particular, in addition to a traditional processor and memory, the processing circuitry 60 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 64 may be configured to access (e.g., write to and/or read from) the memory 62, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 32 may further include software stored internally in, for example, memory 62, or stored in external memory (e.g., database) accessible by the network node 32 via an external connection. The software may be executable by the processing circuitry 60. The processing circuitry 60 may be configured to control any of the methods and/or processes described herein and/or to cause such methods, and/or processes to be performed, e.g., by the network node 32. The memory 62 is configured to store data, programmatic software code and/or other information described herein. In some embodiments, the software may include instructions stored in memory 62 that, when executed by the processor 64, causes the processing circuitry 60 and/or configures the network node 32 to perform the processes described herein with respect to the network node 32.

In FIG. 2, the connection between the devices UE 12, AMF node 16, UDM node 18 and network node 32 is shown without explicit reference to any intermediary devices or connections. However, it should be understood that intermediary devices and/or connections may exist between these devices, although not explicitly shown.

Although FIG. 2 shows registration initiator 26, slice registrator 28 and identification provider 30 as being within a respective processor, it is contemplated that these elements may be implemented such that a portion of the elements is stored in a corresponding memory within the processing circuitry. In other words, the elements may be implemented in hardware or in a combination of hardware and software within the processing circuitry.

In some embodiments, such as, for example, where the information and identifiers described herein are performed during the UE Configuration Update procedure (instead of a UE Registration procedure), as described above, the registration initiator 26 may be called an “updater 26” and the slice registrator 28 may be called an “update provider 28”. Thus, “registration initiator” may be referred to herein interchangeably as “updater”; and “slice registrator” may be referred to herein interchangeably as “update provider”.

FIG. 3 is a flowchart of an example process in a UE 12 according to some embodiments of the present disclosure. One or more Blocks and/or functions and/or methods performed by UE 12 may be performed by one or more elements of UE 12 such as by registration initiator 26 in processing circuitry 36, processor 40, memory 38, communication interface 34, etc. The example method includes using (Block S100), such via registration initiator 26, processing circuitry 36, processor 40, memory 38 and/or communication interface 34, at least one associated identifier, each associated identifier being associated with a respective isolated set of single-network slice selection assistance information (S-NSSAI).

In some embodiments, the method includes one or more of: sending, such via registration initiator 26, processing circuitry 36, processor 40, memory 38 and/or communication interface 34, a registration request message comprising a default subscription permanent identifier (SUPI) associated with the UE; receiving, such via registration initiator 26, processing circuitry 36, processor 40, memory 38 and/or communication interface 34, a registration accept message comprising the at least one associated identifier and a related configured network slice selection assistance information (NSSAI) per associated identifier; receiving, such via registration initiator 26, processing circuitry 36, processor 40, memory 38 and/or communication interface 34, a UE configuration update message comprising the at least one associated identifier and a related configured network slice selection assistance information (NSSAI) per associated identifier; and storing, such via registration initiator 26, processing circuitry 36, processor 40, memory 38 and/or communication interface 34, the at least one associated identifier and the related configured NSSAI at the UE.

In some embodiments, the method includes one or more of: selecting, such via registration initiator 26, processing circuitry 36, processor 40, memory 38 and/or communication interface 34, a first associated identifier of the at least one associated identifier, the first associated identifier corresponding to a requested NSSAI; the at least one associated identifier is received by the UE from an access and mobility function (AMF) node in one of a registration accept message and an UE configuration update message; and initiating, such via registration initiator 26, processing circuitry 36, processor 40, memory 38 and/or communication interface 34, a slice switching registration according to the selected first associated identifier. In some embodiments, the method includes as a result of the slice switching registration, receiving a second globally unique temporary identifier (5G-GUTI), the second 5G-GUTI overwriting a current 5G-GUTI; and/or switching from a slice associated with an associated identifier to a slice associated with the default SUPI.

In some embodiments, the requested NSSAI is based on the configured NSSAI related to the selected first associated identifier. In some embodiments, the slice switching registration is switching from a currently used set of S-NSSAI to the requested NSSAI. In some embodiments, the currently used set of S-NSSAI corresponds to allowed NSSAI. In some embodiments, the requested NSSAI being in the isolated set of S-NSSAIs that is associated with the selected first associated identifier. In some embodiments, a registration request message corresponding to the slice switching registration implicitly indicates to tear down all protocol data unit (PDU) sessions associated with a currently registered associated identifier or a SUPI, related to S-NSSAIs that do not exist in the requested NSSAI. In some embodiments, the at least one associated identifier being different from a default subscription permanent identifier (SUPI) associated with the UE. In some embodiments, each associated identifier includes one or more of: a SUPI for the isolated set of S-NSSAI; and/or at least one Global Public Subscriber Identifier (GPSI) per S-NSSAI in the set. In some embodiments, each isolated set of S-NSSAI comprises one or more S-NSSAIs.

In some embodiments, the method includes one or more of: storing security information and an associated extensible authentication protocol identity (EAP-ID) at the UE; receiving a request to perform a network slice-specific authentication and authorization (NSSAA) procedure; as a result of the request to perform the NSSAA procedure, using a network slice specific authentication and authorization (NSSAA) Global Public Subscriber Identifier (GPSI) as a key to identify the stored EAP-ID and associated security information corresponding to a requested NSSAI that is subject to NSSAA. In some embodiments, the NSSAA GPSI corresponds to at least one stored GPSI that is associated with an associated identifier; and/or the NSSAA GPSI is indicated in the registration accept message or a UE configuration update message.

FIG. 4 is a flowchart of an example process in an AMF node 16 according to one or more of the techniques in the present disclosure. One or more Blocks and/or functions and/or methods performed by the AMF node 16 may be performed by one or more elements of AMF node 16 such as by slice registrator 28 in processing circuitry 44, memory 46, processor 48, communication interface 42, etc. according to the example process/method. The example method includes using (Block S102), such as via such as by slice registrator 28, processing circuitry 44, memory 46, processor 48 and/or communication interface 42, at least one associated identifier, each associated identifier being associated with a respective isolated set of single-network slice selection assistance information (S-NSSAI).

In some embodiments, the method includes one or more of: receiving, such as via such as by slice registrator 28, processing circuitry 44, memory 46, processor 48 and/or communication interface 42, a registration request message comprising a default subscription permanent identifier (SUPI) associated with the UE; as a result of the registration request message, retrieving, such as via such as by slice registrator 28, processing circuitry 44, memory 46, processor 48 and/or communication interface 42, the at least one associated identifier from a unified data management (UDM) node; creating, such as via such as by slice registrator 28, processing circuitry 44, memory 46, processor 48 and/or communication interface 42, a configured network slice selection assistance information (NSSAI) per associated identifier, the configured NSSAI being based on the related associated identifier; sending, such as via such as by slice registrator 28, processing circuitry 44, memory 46, processor 48 and/or communication interface 42, a registration accept message comprising the at least one associated identifier and the related configured network slice selection assistance information (NSSAI); and storing, such as via such as by slice registrator 28, processing circuitry 44, memory 46, processor 48 and/or communication interface 42, the at least one associated identifier and the related configured NSSAI at the AMF. In some embodiments, the method includes sending, such as via such as by slice registrator 28, processing circuitry 44, memory 46, processor 48 and/or communication interface 42, a UE configuration update message comprising the at least one associated identifier and the related configured network slice selection assistance information (NSSAI) per associated identifier.

In some embodiments, the method includes one or more of: receiving, such as via such as by slice registrator 28, processing circuitry 44, memory 46, processor 48 and/or communication interface 42, a request from the UE to perform a slice switching registration from a currently used set of S-NSSAI to a requested NSSAI; the requested NSSAI being based on the configured NSSAI that is related to a first associated identifier of the at least one identifier; the requested NSSAI being based on a configured NSSAI that is related to the default SUPI; the currently used set of S-NSSAI corresponds to allowed NSSAI; retrieving, such as via such as by slice registrator 28, processing circuitry 44, memory 46, processor 48 and/or communication interface 42, from another AMF node and updating, such as via such as by slice registrator 28, processing circuitry 44, memory 46, processor 48 and/or communication interface 42, the stored at least one associated identifier as a result of the request to perform the slice switching registration procedure; validating, such as via such as by slice registrator 28, processing circuitry 44, memory 46, processor 48 and/or communication interface 42, the retrieved at least one associated identifier; as a result of the request to perform the slice switching registration procedure, participating, such as via such as by slice registrator 28, processing circuitry 44, memory 46, processor 48 and/or communication interface 42, in tearing down all protocol data unit (PDU) sessions associated with a currently registered associated identifier or a SUPI, related to S-NSSAIs that do not exist in the requested NSSAI; and sending, such as via such as by slice registrator 28, processing circuitry 44, memory 46, processor 48 and/or communication interface 42, a registration accept message to the UE, the registration accept message comprising the at least one associated identifier and the related configured NSSAI.

In some embodiments, the requested NSSAI being in the isolated set of S-NSSAIs that is associated with the selected first associated identifier. In some embodiments, the request to perform the slice switching registration implicitly indicates to tear down all protocol data unit (PDU) sessions associated with a currently registered associated identifier. In some embodiments, the at least one associated identifier being different from a default subscription permanent identifier (SUPI) associated with the UE. In some embodiments, each associated identifier includes at least one of: a SUPI for the isolated set of S-NSSAI; and/or at least one Global Public Subscriber Identifier (GPSI) per S-NSSAI in the set. In some embodiments, each isolated set of S-NSSAI comprises one or more S-NSSAIs.

In some embodiments, the method includes one or more of: retrieving, such as via such as by slice registrator 28, processing circuitry 44, memory 46, processor 48 and/or communication interface 42, at least one network slice specific authentication and authorization (NSSAA) Global Public Subscriber Identifier (GPSI) from a unified data management (UDM) node during a registration procedure of the UE to a network; and sending, such as via such as by slice registrator 28, processing circuitry 44, memory 46, processor 48 and/or communication interface 42, the at least one NSSAA-GPSI to the UE, each S-NSSAI that is subject to NSSAA being associated with a respective NSSAI-GPSI, the NSSAI-GPSI being a key to identify an extensible authentication protocol identity (EAP-ID) and associated security information stored at the UE.

In some embodiments, the NSSAA GPSI corresponds to at least one stored GPSI that is associated with an associated identifier; and/or the NSSAA GPSI is indicated in the registration accept message or a UE configuration update message.

FIG. 5 is a flowchart of an example process in an UDM node 18 according to one or more of the techniques in the present disclosure. One or more Blocks and/or functions and/or methods performed by the UDM node 18 may be performed by one or more elements of UDM node 18 such as by identification provider 30 in processing circuitry 52, memory 54, processor 56, communication interface 50, etc. according to the example process/method. The example method includes receiving (Block S104), such as via identification provider 30, processing circuitry 52, memory 54, processor 56 and/or communication interface 50, a request to retrieve subscription data for a user equipment (UE) during a registration procedure of the UE to a network. The method includes sending (Block S106), such as via identification provider 30, processing circuitry 52, memory 54, processor 56 and/or communication interface 50, the subscription data to an access and mobility function (AMF) node as a result of the request, the subscription data comprising at least one associated identifier, each associated identifier being associated with a respective isolated set of single-network slice selection assistance information (S-NSSAI).

In some embodiments, the UDM node is pre-configured with the at least one associated identifier corresponding to the UE. In some embodiments, the at least one associated identifier being different from a default subscription permanent identifier (SUPI) associated with the UE. In some embodiments, each associated identifier includes one or more of: a SUPI for the isolated set of S-NSSAI; and at least one Global Public Subscriber Identifier (GPSI) per S-NSSAI in the set. In some embodiments, each isolated set of S-NSSAI comprises one or more S-NSSAIs. In some embodiments, the method includes providing, such as via identification provider 30, processing circuitry 52, memory 54, processor 56 and/or communication interface 50, at least one network slice specific authentication and authorization (NSSAA) Global Public Subscriber Identifier (GPSI) associated with a user equipment (UE), each S-NSSAI that is subject to NSSAA being associated with a respective NSSAI-GPSI, the NSSAI-GPSI being a key to identify an extensible authentication protocol identity (EAP-ID) and associated security information stored at the UE.

In some embodiments, the NSSAA GPSI corresponds to at least one stored GPSI that is associated with an associated identifier. In some embodiments, the NSSAA GPSI is indicated in the retrieve subscription data; and/or the at least one NSSAA GPSI is provided to an access and mobility function (AMF) node during one of a registration procedure of the UE to a network or a UE configuration update message.

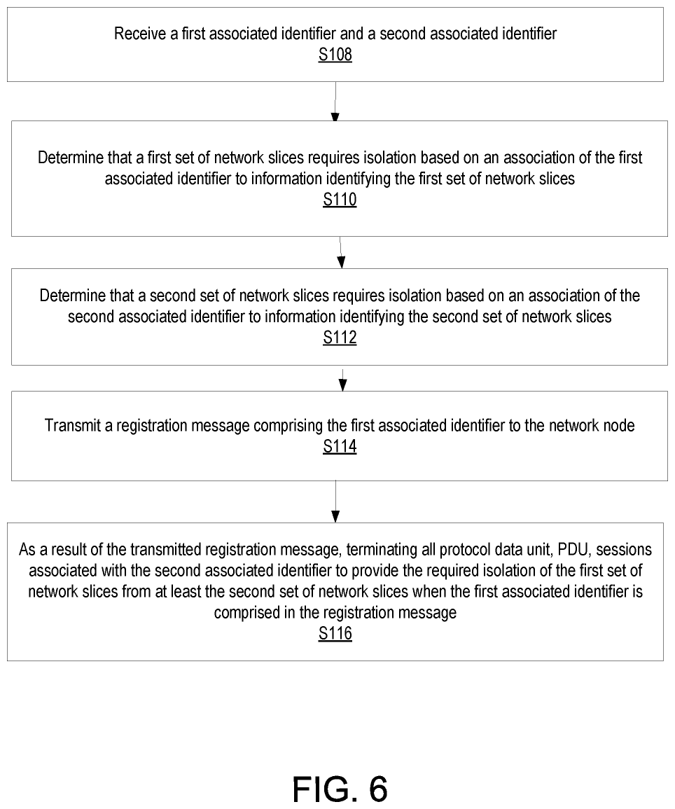

FIG. 6 is a flowchart of an example process in a UE 12 according to some embodiments of the present disclosure. One or more Blocks and/or functions and/or methods performed by UE 12 may be performed by one or more elements of UE 12 such as by registration initiator 26 in processing circuitry 36, processor 40, memory 38, communication interface 34, etc. The example method includes receiving (Block S108), such as via such as by registration initiator 26, processing circuitry 36, processor 40, memory 38 and/or communication interface 34, a first associated identifier and a second associated identifier. The method includes determining (Block S110), such as via such as by registration initiator 26, processing circuitry 36, processor 40, memory 38 and/or communication interface 34, that a first set of network slices requires isolation based on an association of the first associated identifier to information identifying the first set of network slices.

The method includes determining (Block S112), such as via such as by registration initiator 26, processing circuitry 36, processor 40, memory 38 and/or communication interface 34, that a second set of network slices requires isolation based on an association of the second associated identifier to information identifying the second set of network slices. The method includes transmitting (Block S114), such as via such as by registration initiator 26, processing circuitry 36, processor 40, memory 38 and/or communication interface 34, a registration message comprising the first associated identifier to the network node. The method includes as a result of the transmitted registration message, terminating (Block S116), such as via such as by registration initiator 26, processing circuitry 36, processor 40, memory 38 and/or communication interface 34, all protocol data unit, PDU, sessions associated with the second associated identifier to provide the required isolation of the first set of network slices from at least the second set of network slices when the first associated identifier is comprised in the registration message.

In some embodiments, the information identifying the first set of network slices comprises a first set of network slice selection assistance information, NSSAI; and the information identifying the second set of network slices comprises a second set of NSSAI. In some embodiments, receiving the first and second associated identifiers in one of a registration accept message and a UE configuration update message from the network node. In some embodiments, transmitting the registration message comprising the first associated identifier further comprises selecting, such as via such as by registration initiator 26, processing circuitry 36, processor 40, memory 38 and/or communication interface 34, the first associated identifier and initiating a slice switching registration using the selected first associated identifier.

In some embodiments, the method further includes as a result of the slice switching registration, receiving, such as via such as by registration initiator 26, processing circuitry 36, processor 40, memory 38 and/or communication interface 34, a second globally unique temporary identifier, 5G-GUTI, the second 5G-GUTI overwriting a current 5G-GUTI. In some embodiments, the slice switching registration comprises switching, such as via such as by registration initiator 26, processing circuitry 36, processor 40, memory 38 and/or communication interface 34, from the second set of network slices that is currently used at the UE to the first set of network slices that is associated with the first associated identifier comprised in the registration message.

In some embodiments, the first associated identifier in the registration message implicitly indicates to tear down all the PDU sessions associated with the second associated identifier. In some embodiments, the first associated identifier comprises a subscription permanent identifier, SUPI, and a Global Public Subscriber Identifier, GPSI, per network slice in the first set of network slices. In some embodiments, the method further includes storing, such as via such as by registration initiator 26, processing circuitry 36, processor 40, memory 38 and/or communication interface 34, security information and an extensible authentication protocol identity, EAP-ID, at the UE; receiving, such as via such as by registration initiator 26, processing circuitry 36, processor 40, memory 38 and/or communication interface 34, a request to perform a network slice-specific authentication and authorization, NSSAA, procedure for a first network slice in the first set of network slices; and as a result of the request to perform the NSSAA procedure, using, such as via such as by registration initiator 26, processing circuitry 36, processor 40, memory 38 and/or communication interface 34, the GPSI that is associated with the first network slice as a key to identify the stored security information and the EAP-ID to use in the NSSAA procedure for the first network slice.

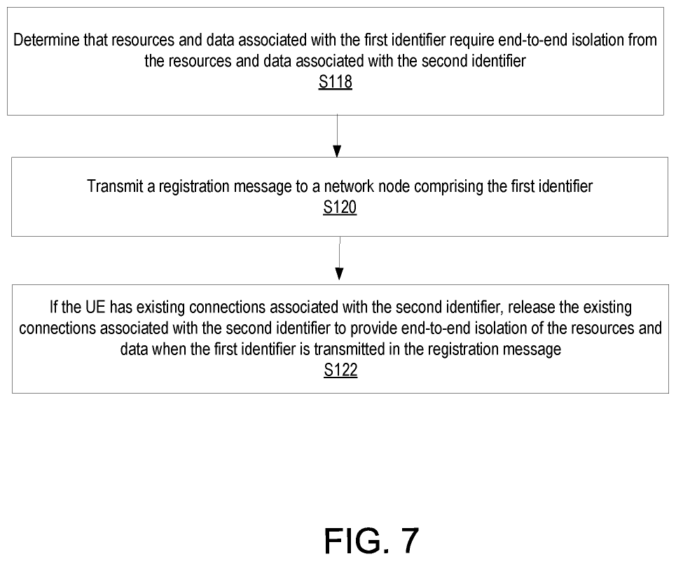

FIG. 7 is a flowchart of an example process in a UE 12 according to some embodiments of the present disclosure. One or more Blocks and/or functions and/or methods performed by UE 12 may be performed by one or more elements of UE 12 such as by registration initiator 26 in processing circuitry 36, processor 40, memory 38, communication interface 34, etc. The example method includes determining (Block S118), such as via such as by registration initiator 26, processing circuitry 36, processor 40, memory 38 and/or communication interface 34, that resources and data associated with the first identifier require end-to-end isolation from the resources and data associated with the second identifier. The method includes transmitting (Block S120), such as via such as by registration initiator 26, processing circuitry 36, processor 40, memory 38 and/or communication interface 34, a registration message to a network node comprising the first identifier. The method includes if the UE 12 has existing connections associated with the second identifier, releasing (Block S122), such as via such as by registration initiator 26, processing circuitry 36, processor 40, memory 38 and/or communication interface 34, the existing connections associated with the second identifier to provide end-to-end isolation of the resources and data when the first identifier is transmitted in the registration message.

In some embodiments, the first identifier and the second identifier correspond to a first and a second slice identifier. In some embodiments, the first identifier and the second identifier correspond to a first and a second vertical identifier. In some embodiments, the first identifier and the second identifier correspond to a first and a second Subscription Permanent Identifier, SUPI, or Global Public Subscriber Identifier, GPSI. In some embodiments, the resources associated with the first identifier correspond to at least one of a first memory space, a first processing resource and a first network resource and the resources associated with the second identifier correspond to at least one of a second memory space, a second processing resource and a second network resource, the resources associated with the first identifier being isolated from the resources associated with the second identifier.

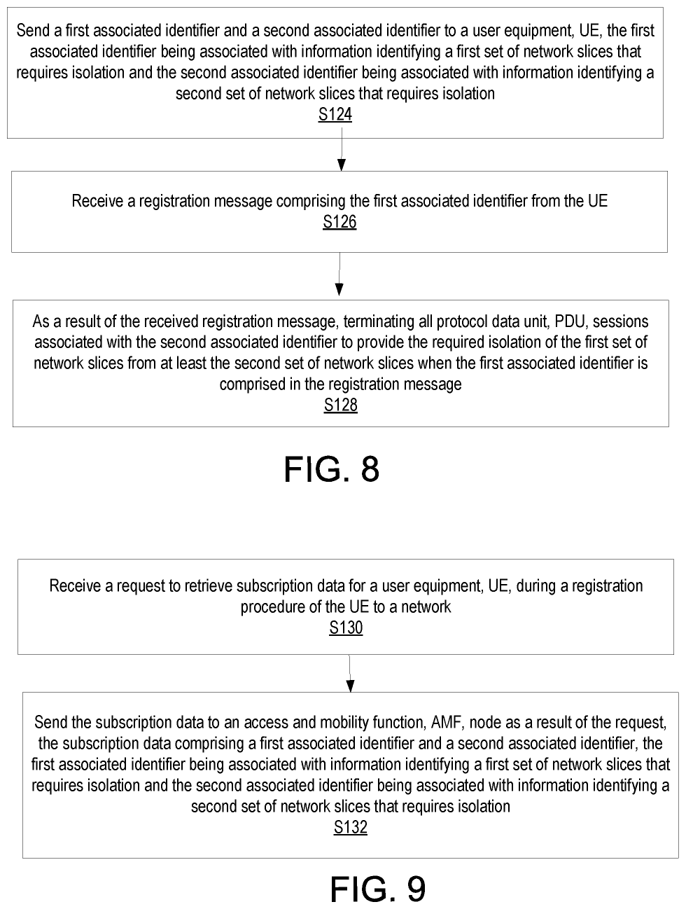

FIG. 8 is a flowchart of an example process in an AMF node 16 according to one or more of the techniques in the present disclosure. One or more Blocks and/or functions and/or methods performed by the AMF node 16 may be performed by one or more elements of AMF node 16 such as by slice registrator 28 in processing circuitry 44, memory 46, processor 48, communication interface 42, etc. according to the example process/method. The example method includes sending (Block S124), such as via slice registrator 28, processing circuitry 44, memory 46, processor 48 and/or communication interface 42, a first associated identifier and a second associated identifier to a user equipment, UE, the first associated identifier being associated with information identifying a first set of network slices that requires isolation and the second associated identifier being associated with information identifying a second set of network slices that requires isolation. The method includes receiving (Block S126), such as via slice registrator 28, processing circuitry 44, memory 46, processor 48 and/or communication interface 42, a registration message comprising the first associated identifier from the UE. The method includes as a result of the received registration message, terminating (Block S128), such as via slice registrator 28, processing circuitry 44, memory 46, processor 48 and/or communication interface 42, all protocol data unit, PDU, sessions associated with the second associated identifier to provide the required isolation of the first set of network slices from at least the second set of network slices when the first associated identifier is comprised in the registration message.

In some embodiments, the information identifying the first set of network slices comprises a first set of network slice selection assistance information, NSSAI; and the information identifying the second set of network slices comprises a second set of NSSAI. In some embodiments, sending the first and second associated identifiers in one of a registration accept message and a UE configuration update message. In some embodiments, the method further includes as a result of the received the registration message comprising the first associated identifier, performing, such as via slice registrator 28, processing circuitry 44, memory 46, processor 48 and/or communication interface 42, a slice switching registration using the first associated identifier. In some embodiments, the method further includes as a result of the slice switching registration, sending, such as via slice registrator 28, processing circuitry 44, memory 46, processor 48 and/or communication interface 42, a second globally unique temporary identifier, 5G-GUTI, to the UE, the second 5G-GUTI overwriting a current 5G-GUTI at the UE.

In some embodiments, the slice switching registration comprises switching, such as via slice registrator 28, processing circuitry 44, memory 46, processor 48 and/or communication interface 42, the UE from the second set of network slices to the first set of network slices that is associated with the first associated identifier comprised in the registration message. In some embodiments, the first associated identifier in the registration message implicitly indicates to tear down all the PDU sessions associated with the second associated identifier. In some embodiments, the first associated identifier comprises a subscription permanent identifier, SUPI, and a Global Public Subscriber Identifier, GPSI, per network slice in the first set of network slices. In some embodiments, the method further includes sending, such as via slice registrator 28, processing circuitry 44, memory 46, processor 48 and/or communication interface 42, security information and an extensible authentication protocol identity, EAP-ID, to the UE, the GPSI that is associated with the first network slice being a key for the UE to identify the security information and the EAP-ID to use in a network slice-specific authentication and authorization, NSSAA, procedure for the first network slice.

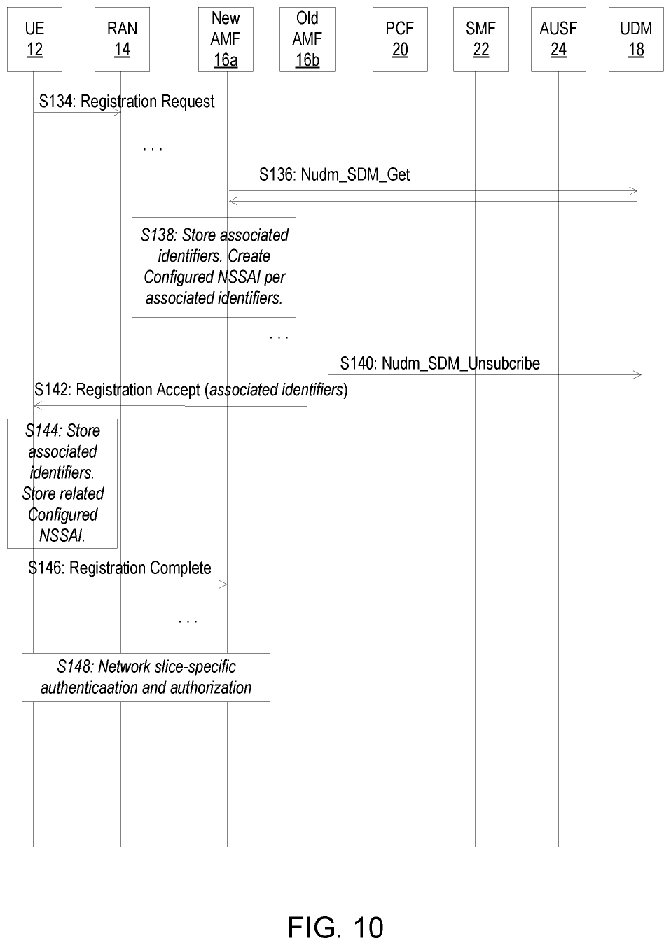

FIG. 9 is a flowchart of an example process in an UDM node 18 according to one or more of the techniques in the present disclosure. One or more Blocks and/or functions and/or methods performed by the UDM node 18 may be performed by one or more elements of UDM node 18 such as by identification provider 30 in processing circuitry 52, memory 54, processor 56, communication interface 50, etc. according to the example process/method. The example method includes receiving (Block S130), such as by identification provider 30, processing circuitry 52, memory 54, processor 56 and/or communication interface 50, a request to retrieve subscription data for a user equipment, UE, during a registration procedure of the UE to a network. The method includes sending (Block S132), such as by identification provider 30, processing circuitry 52, memory 54, processor 56 and/or communication interface 50, the subscription data to an access and mobility function, AMF, node as a result of the request, the subscription data comprising a first associated identifier and a second associated identifier, the first associated identifier being associated with information identifying a first set of network slices that requires isolation and the second associated identifier being associated with information identifying a second set of network slices that requires isolation.

In some embodiments, the first and second associated identifiers comprise a subscription permanent identifier, SUPI, and a Global Public Subscriber Identifier, GPSI, per network slice in the respective set of network slices. In some embodiments, the method further includes sending, such as by identification provider 30, processing circuitry 52, memory 54, processor 56 and/or communication interface 50, security information and an extensible authentication protocol identity, EAP-ID, to the AMF node, the GPSI being a key for the UE to identify the security information and the EAP-ID to use in a network slice-specific authentication and authorization, NSSAA, procedure for a network slice that is associated with the GPSI.

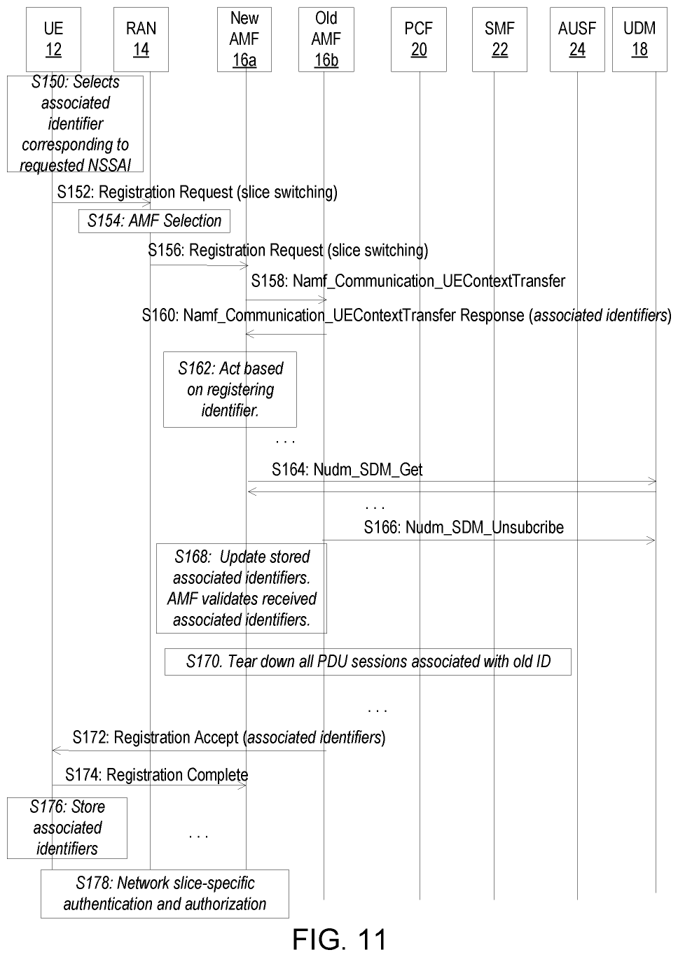

Having generally described arrangements for resource isolation via associated identifiers, a more detailed description of some of the embodiments are provided as follows with reference to FIGS. 10 and 11, and which may be implemented by UE 12, AMF node 16, UDM node 18 and/or network node 32.

Initial Registration of Default SUPI

FIG. 10 is a call flow diagram that illustrates an example initiation registration of the UE 12 according to one embodiment of the present disclosure. The call flow diagram in FIG. 10 shows an example typical registration for TS 23.502, but also including the additional impacts that may be used in some embodiments of the present disclosure. For example, FIG. 10 may be considered to show an example of how an initial registration procedure of the UE 12 to a network, e.g., 5GS, may be modified to support the new slice-switching registration proposed in the present disclosure.

In some embodiments, the UDM node 18 is pre-configured with the associated-IDs in the UE's 12 user profile (e.g., default user profile).

The example initial registration method in FIG. 10 may include one or more of the following steps (the description below will focus primarily on the impacts to the registration procedure provided by some embodiments of the present disclosure):
In step S134, the UE 12 may send a registration request. Steps 1-14a may be the same as in the existing registration procedure in TS 23.502;
In step S136, the AMF node 16a retrieves the associated-IDs associated with the UE 12 from the UDM node 18. The Nudm_SDM_Get service may be used and may be considered a service provided by the UDM node 18, that allows a consumer network function (NF) (in this case AMF) to retrieve a UE's 12 subscription data. The UDM node 18 may be pre-configured with an associated-identifier Information element (IE) as an additional element in the Access and Mobility subscription related data. The associated-identifier IE may contain a list of SUPIs, GPSIs and related subscribed S-NSSAIs for each SUPI/GPSI. This information, associated-identifier IE, may be returned to the AMF node 16a in step S136, and stored in the AMF node 16a.
Based on the information (in the associated-identifier IE) from the UDM node 18, the AMF node 16a may create a Configured NSSAI per associated-identifier.
In some embodiments, if this is a periodic registration, then the AMF node 16a does not impact the currently registered associated-identifier, if applicable.
Following step S138 may be steps 14c-19c in the existing registration procedure in TS 23.502, including the old AMF node 16b unsubscribing in step S140.
In step S142, the associated-identifiers and/or the related Configured NSSAI received and stored at the AMF node 16a are included in the registration accept that is sent to the UE 12. The UE 12 stores the received associated-identifiers in step S144.
In step S146, UE 12 may send a registration complete message to the new AMF 16a.
Following step S146 may be steps 22-25 in the existing registration procedure in TS 23.502, including the NSSAA as in step S148.

Slice-Switching Registration

FIG. 11 is a call flow diagram that illustrates an example slice-switching registration initiated by the UE 12 according to one embodiment of the present disclosure. In some embodiments, in the slice-switching registration in FIG. 11 it may be assumed that the UE 12 has already performed an initial registration procedure (e.g., such as according to FIG. 10).

The call flow diagram in FIG. 11 shows when the UE 12 determines to use a new network slice (e.g., a network slice that is different than the network slice currently being used by the UE 12) associated with a new associated-identifier. The call flow diagram in FIG. 11 may be considered to show the impact of a new slice-switching registration proposed by the present disclosure on the existing registration procedure depicted in TS 23.502. The example slice-switching registration procedure shown in FIG. 11 may include one or more of the following (the description below will focus primarily on the impacts to the registration procedure provided by some embodiments of the present disclosure):
In step S150, the UE 12 selects the associated-identifier corresponding to a requested NSSAI (e.g., created based on the Configured NSSAI for the selected Associated-Identifier) and in step S152, initiates a slice switching registration by sending a registration request to RAN 14 using a new registration type (e.g., slice-switching registration type).
The slice switching registration may be from a currently used set of S-NSSAI to the requested NSSAI. In other embodiments, the slice switching registration is switching from a currently registered associated identifier or SUPI, related to S-NSSAIs that do not exist in the requested NSSA (e.g., some S-NSSAIs may be shared between the set of S-NSSAIs). In some embodiments, the slices in the set slice for the default SUPI also can be switched just like an Associated-Identifier. The default SUPI however controls the complete UE Registration/De-Registration.
In step S154, an AMF is selected. If this is a slice switching registration, and not e.g., an initial or mobility registration, then the selected AMF, e.g., AMF 16b, acquires the associated-identifiers from the old-AMF, e.g., AMF node 16a, in addition to other information.
In step S156, RAN 14 forwards the registration request to the selected AMF node 16b.
In step S158, a UE context transfer is initiated and, in step S160, the selected AMF node 16b receives associated-identifiers from the old-AMF node 16a. In some embodiments, the associated-identifiers are used between the UE and the AMF, and then the AMF uses existing SUPI (i.e., default SUPI) or 5G-Globally Unique Temporary Identifier (GUTI) towards all other network functions (NFs). This may make all other network functions (NFs) agnostic, besides that the UDM that is configured with the additional information and provides it to the AMF.
Step S158 may also use existing the existing ID i.e., 5G-GUTI and then the old AMF 16b provides the UE context that may contain the new information.
In step S162, the AMF node 16b validates the registering associated-identifier. The AMF node 16b may always use the default SUPI for the interaction with the UDM node 18.
Following step S162, may steps 6-14a of the existing registration procedure in TS 23.502.
In step S164, the new AMF node 16b gets the UE's 12 subscription information.
Following step S164, may steps 14c-14d of the existing registration procedure in TS 23.502.
In step S166, the old AMF node 16b unsubscribes.
In step S168, the new AMF node 16a updates and stores the received associated-identifiers received from step S1 60 if any.
In step S170, the AMF node 16 tears down all PDU sessions associated with the deregistering (other) associated-identifier including the default SUPI (e.g., old associated-identifier).
Following step S170, may steps 15-19c of the existing registration procedure in TS 23.502.
In step S172, the associated-identifiers may be included in the registration accept message and the related Allowed NSSAI e.g., from the new AMF node 16b to the UE 12. The UE 12 stores the associated-identifiers. Since this is a slice-switching registration, there may be a new globally unique temporary identifier (5G-GUTI) is based on the default SUPI. The new 5G-GUTI may overwrite the old 5G-GUTI. The 5G-GUTI may be considered a temporary ID used to refer to the UE context in the AMF and part of it may be used to refer to the AMF Set and that UE provides in radio resource control (RRC) to NG-RAN.
In step S174, UE 12 may send registration complete message to AMF 16a.
In step S176, UE 12 may store all the associated-identifiers that were included in the registration accept message in step S172.
In step S178, a NSSAA procedure may be initiated.

In some embodiments, the default SUPI set of slices may also be subject to slice switching registration if e.g., the UE 12 wants to switch back from an Associated-Identifier to the default SUPI. Following is one example order of slice switching:
1) UE Initial Registration (Default SUPI);
2) Slice switching Registration to Associated-Identifier;
3) Slice switching Registration to default SUPI;
4) Slice switching Registration to Associated-Identifier; and
5) UE Deregistration SUPI.

Enabling Awareness of NSSAA Data

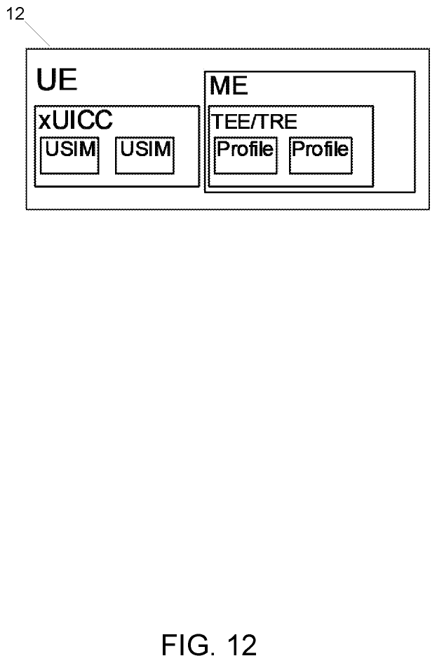

For enabling the UE 12 to know the user identity (EAP-ID) to be used for NSSAA and the security information to be used for the authentication during the NSSAA, one or more of the following may be performed:
The S-NSSAIs in the Configured NSSAI that are subject for NSSAA gets an associated GPSI (NSSAA-GPSI) that can be provided (e.g., by AMF node 16, which gets it from the UDM with subscription data) along with the Configured NSSAI or as separate information. One or more of the information described herein throughout the present disclosure may be provided (e.g., by AMF node 16) to the UE 12 during registration (e.g., initial registration or slice-switching registration) or UE Configuration Update procedures or can be pre-configured.
In some embodiments, this NSSAA-GPSI may simply be a GPSI that is indicated as to be used for NSSAA, and if there is one GPSI in the list and the S-NSSAI is subject for NSSAA then the GPSI is the NSAA-GPSI.
When the UE 12 is requested to provide the EAP-ID for NSSAA, the UE 12 may send the NSSAA-GPSI to the AMF node 16 (e.g., see step 2-3 in clause 4.2.9.2 of 3GPP TS 23.502).
In some embodiments, the EAP-ID can be the, or one of, the actual GPSI stored with the associated identifier (if one GPSI it may be a same as NSAA-GPSI) and otherwise the one to be NSSAA-GPSI may be indicated in e.g., the subscription data.
The security information to be used for the authentication during the NSSAA may be stored or configured in the UE 12 and the NSSAA-GPSI may be stored in the UE 12. The NSSAA-GPSI may function as a key for the security information to enable the UE 12 to look-up the security information during the NSSAA procedure (e.g., use the NSSAA-GPSI to look-up the EAP-ID and/or the corresponding security information for the NSSAA). The information (e.g., security information, credentials, EAP-ID and/or NSSAA-GPSI) in the UE 12 can be stored in a UICC application (e.g., USIM) or in the ME in a secure environment (see an example UE in FIG. 12). The UICC application e.g., often USIM is running in the UICC, which may be an old UICC (e.g., cards that can be inserted and removed into a device) or eUICC (that is embedded into the device chip) or be a later variant e.g., iUICC (that is integrated into a chip of the UE that it uses also for other purposes). These may be referred to as UICC in general.

Some embodiments may include one or more of the following:

Embodiment A1. A method implemented in a user equipment (UE), the method comprising:
using at least one associated identifier, each associated identifier being associated with a respective isolated set of single-network slice selection assistance information (S-NSSAI).

Embodiment A2. The method of Embodiment A1, wherein the using is during a registration procedure of the UE to a network and/or a UE configuration update procedure and/or comprises one or more of:
sending a registration request message comprising a default subscription permanent identifier (SUPI) associated with the UE;
receiving a registration accept message comprising the at least one associated identifier and a related configured network slice selection assistance information (NSSAI) per associated identifier;
receiving a UE configuration update message comprising the at least one associated identifier and a related configured network slice selection assistance
information (NSSAI) per associated identifier; and storing the at least one associated identifier and the related configured NSSAI at the UE.

Embodiment A3. The method of any one of Embodiments A1 and A2, wherein the using is during a registration procedure of the UE to a network and/or a UE configuration update procedure and/or comprises one or more of:
selecting a first associated identifier of the at least one associated identifier, the first associated identifier corresponding to a requested NSSAI;
the at least one associated identifier is received by the UE from an access and mobility function (AMF) node in one of a registration accept message and an UE configuration update message; and
initiating a slice switching registration according to the selected first associated identifier;
as a result of the slice switching registration, receiving a second globally unique temporary identifier (5G-GUTI), the second 5G-GUTI overwriting a current 5G-GUTI; and/or
switching from a slice associated with an associated identifier to a slice associated with the default SUPI.

Embodiment A4. The method of Embodiment A3, wherein one of more of:
the requested NSSAI is based on the configured NSSAI related to the selected first associated identifier;
the slice switching registration is switching from a currently used set of S-NSSAI to the requested NSSAI;
the currently used set of S-NSSAI corresponds to allowed NSSAI;
the requested NSSAI being in the isolated set of S-NSSAIs that is associated with the selected first associated identifier;
a registration request message corresponding to the slice switching registration implicitly indicates to tear down all protocol data unit (PDU) sessions associated with a currently registered associated identifier or a SUPI, related to S-NSSAIs that do not exist in the requested NSSAI;
the at least one associated identifier being different from a default subscription permanent identifier (SUPI) associated with the UE;
each associated identifier includes one or more of:
   a SUPI for the isolated set of S-NSSAI; and/or
   at least one Global Public Subscriber Identifier (GPSI) per S-NSSAI in the set; and/or
each isolated set of S-NSSAI comprises one or more S-NSSAIs.

Embodiment A5. The method of any one of Embodiments A1-A4, further comprising one or more of:
storing security information and an associated extensible authentication protocol identity (EAP-ID) at the UE;
receiving a request to perform a network slice-specific authentication and authorization (NSSAA) procedure;
as a result of the request to perform the NSSAA procedure, using a network slice specific authentication and authorization (NSSAA) Global Public Subscriber Identifier (GPSI) as a key to identify the stored EAP-ID and associated security information corresponding to a requested NSSAI that is subject to NSSAA;
the NSSAA GPSI corresponds to at least one stored GPSI that is associated with an associated identifier; and/or
the NSSAA GPSI is indicated in the registration accept message or a UE configuration update message.

Embodiment B1. A user equipment (UE) comprising processing circuitry and/or a communication interface, the UE and/or the processing circuitry and/or the communication interface configured to cause the UE to:
use at least one associated identifier, each associated identifier being associated with a respective isolated set of single-network slice selection assistance information (S-NSSAI).

Embodiment B2. The UE of Embodiment B1, wherein the UE and/or the processing circuitry and/or the communication interface is configured to cause the UE to use during a registration procedure of the UE to a network and/or a UE configuration update procedure and/or by being configured to cause the UE to one or more of:
send a registration request message comprising a default subscription permanent identifier (SUPI) associated with the UE;
receive a registration accept message comprising the at least one associated identifier and a related configured network slice selection assistance information (NSSAI) per associated identifier;
receive a UE configuration update message comprising the at least one associated identifier and a related configured network slice selection assistance information (NSSAI) per associated identifier; and
store the at least one associated identifier and the related configured NSSAI at the UE.

Embodiment B3. The UE of any one of Embodiments B1 and B2, wherein the UE and/or the processing circuitry and/or the communication interface is configured to cause the UE to use during a registration procedure of the UE to a network and/or a UE configuration update procedure by being configured to cause the UE to one or more of:
select a first associated identifier of the at least one associated identifier, the first associated identifier corresponding to a requested NSSAI;
the at least one associated identifier is received by the UE from an access and mobility function (AMF) node in one of a registration accept message and a UE configuration update message;
initiate a slice switching registration according to the selected first associated identifier;
as a result of the slice switching registration, receive a second globally unique temporary identifier (5G-GUTI), the second 5G-GUTI overwriting a current 5G-GUTI; and/or
switch from a slice associated with an associated identifier to a slice associated with the default SUPI.

Embodiment B4. The UE of Embodiment B3, wherein one or more of:
the requested NSSAI is based on the configured NSSAI related to the selected first associated identifier;
the slice switching registration is switching from a currently used set of S-NSSAI to the requested NSSAI;
the currently used set of S-NSSAI corresponds to allowed NSSAI;
the requested NSSAI being in the isolated set of S-NSSAIs that is associated with the selected first associated identifier;
a registration request message corresponding to the slice switching registration implicitly indicates to tear down all protocol data unit (PDU) sessions associated with a currently registered associated identifier or a SUPI, related to S-NSSAIs that do not exist in the requested NSSAI;
the at least one associated identifier being different from a default subscription permanent identifier (SUPI) associated with the UE;
each associated identifier includes one or more of:
   a SUPI for the isolated set of S-NSSAI; and/or
   at least one Global Public Subscriber Identifier (GPSI) per S-NSSAI in the set; and/or
each isolated set of S-NSSAI comprises one or more S-NSSAIs.

Embodiment B5. The UE of any one of Embodiments B1-B4, wherein the UE and/or the processing circuitry and/or the communication interface is configured to cause the UE to one or more of:
store security information and an associated extensible authentication protocol identity (EAP-ID) at the UE;
receive a request to perform a network slice-specific authentication and authorization (NSSAA) procedure;
as a result of the request to perform the NSSAA procedure, use a network slice specific authentication and authorization (NSSAA) Global Public Subscriber Identifier (GPSI) as a key to identify the stored EAP-ID and associated security information corresponding to a requested NSSAI that is subject to NSSAA;
the NSSAA GPSI corresponds to at least one stored GPSI that is associated with an associated identifier; and/or
the NSSAA GPSI is indicated in the registration accept message or a UE configuration update message.

Embodiment C1. A method implemented in an access and mobility function (AMF) node, the method comprising:
using at least one associated identifier, each associated identifier being associated with a respective isolated set of single-network slice selection assistance information (S-NSSAI).

Embodiment C2. The method of Embodiment C1, wherein the using is during a registration procedure of the UE to a network and/or a UE configuration update procedure and/or comprises one or more of:
receiving a registration request message comprising a default subscription permanent identifier (SUPI) associated with the UE;
as a result of the registration request message, retrieving the at least one associated identifier from a unified data management (UDM) node;
creating a configured network slice selection assistance information (NSSAI) per associated identifier, the configured NSSAI being based on the related associated identifier;
sending a registration accept message comprising the at least one associated identifier and the related configured network slice selection assistance information (NSSAI);
sending a UE configuration update message comprising the at least one associated identifier and the related configured network slice selection assistance information (NSSAI) per associated identifier; and
storing the at least one associated identifier and the related configured NSSAI at the AMF.

Embodiment C3. The method of any one of Embodiments C1 and C2, wherein the using is during a registration procedure of the UE to a network and/or a UE configuration update procedure and comprises one or more of:
receiving a request from the UE to perform a slice switching registration from a currently used set of S-NSSAI to a requested NSSAI;
the requested NSSAI being based on the configured NSSAI that is related to a first associated identifier of the at least one identifier;
the requested NSSAI being based on a configured NSSAI that is related to the default SUPI;
the currently used set of S-NSSAI corresponds to allowed NSSAI;
retrieving from another AMF node and updating the stored at least one associated identifier as a result of the request to perform the slice switching registration procedure;
validating the retrieved at least one associated identifier;
as a result of the request to perform the slice switching registration procedure, participating in tearing down all protocol data unit (PDU) sessions associated with a currently registered associated identifier or a SUPI, related to S-NSSAIs that do not exist in the requested NSSAI; and
sending a registration accept message to the UE, the registration accept message comprising the at least one associated identifier and the related configured NSSAI.

Embodiment C4. The method of any one of Embodiments C1-C3, wherein one or more of:
the requested NSSAI being in the isolated set of S-NSSAIs that is associated with the selected first associated identifier;
the request to perform the slice switching registration implicitly indicates to tear down all protocol data unit (PDU) sessions associated with a currently registered associated identifier;
the at least one associated identifier being different from a default subscription permanent identifier (SUPI) associated with the UE;
each associated identifier includes at least one of:
   a SUPI for the isolated set of S-NSSAI; and/or
   at least one Global Public Subscriber Identifier (GPSI) per S-NSSAI in the set; and
each isolated set of S-NSSAI comprises one or more S-NSSAIs.

Embodiment C5. The method of any one of Embodiments C1-C4, further comprising:
retrieving at least one network slice specific authentication and authorization (NSSAA) Global Public Subscriber Identifier (GPSI) from a unified data management (UDM) node during a registration procedure of the UE to a network; and
sending the at least one NSSAA-GPSI to the UE, each S-NSSAI that is subject to NSSAA being associated with a respective NSSAI-GPSI, the NSSAI-GPSI being a key to identify an extensible authentication protocol identity (EAP-ID) and associated security information stored at the UE.

Embodiment C6. The method of Embodiment C5, wherein one or more of:
the NSSAA GPSI corresponds to at least one stored GPSI that is associated with an associated identifier; and/or
the NSSAA GPSI is indicated in the registration accept message or a UE configuration update message.

Embodiment D1. An access and mobility management function (AMF) node comprising processing circuitry and/or a communication interface, the AMF node and/or the processing circuitry and/or the communication interface configured to cause the AMF node to:
use at least one associated identifier, each associated identifier being associated with a respective isolated set of single-network slice selection assistance information (S-NSSAI).

Embodiment D2. The AMF node of Embodiment D1, wherein the AMF node and/or the processing circuitry and/or the communication interface is configured to cause the AMF node to use during a registration procedure of the UE to a network and/or a UE configuration update message by being configured to cause the AMF node to one or more of:
receive a registration request message comprising a default subscription permanent identifier (SUPI) associated with the UE;
as a result of the registration request message, retrieve the at least one associated identifier from a unified data management (UDM) node;
create a configured network slice selection assistance information (NSSAI) per associated identifier, the configured NSSAI being based on the related associated identifier;
send a registration accept message comprising the at least one associated identifier and the related configured network slice selection assistance information (NSSAI);
send a UE configuration update message comprising the at least one associated identifier and the related configured network slice selection assistance information (NSSAI) per associated identifier; and
store the at least one associated identifier and the related configured NSSAI at the AMF.

Embodiment D3. The AMF node of any one of Embodiments D1 and D2, wherein the AMF node and/or the processing circuitry and/or the communication interface is configured to cause the AMF node to use during a registration procedure of the UE to a network and/or a UE configuration update procedure by being configured to cause the AMF node to one or more of:
receive a request from the UE to perform a slice switching registration from a currently used set of S-NSSAI to a requested NSSAI;
the requested NSSAI being based on the configured NSSAI that is related to a first associated identifier of the at least one identifier;
the requested NSSAI being based on a configured NSSAI that is related to the default SUPI;
the currently used set of S-NSSAI corresponds to allowed NSSAI;
retrieve from another AMF node and updating the stored at least one associated identifier as a result of the request to perform the slice switching registration procedure;
validate the retrieved at least one associated identifier;
as a result of the request to perform the slice switching registration procedure, participate in tearing down all protocol data unit (PDU) sessions associated with a currently registered associated identifier or a SUPI, related to S-NSSAIs that do not exist in the requested NSSAI; and
send a registration accept message to the UE, the registration accept message comprising the at least one associated identifier and the related configured NSSAI.

Embodiment D4. The AMF node of any one of Embodiments D1-D3, wherein one or more of:
the requested NSSAI being in the isolated set of S-NSSAIs that is associated with the selected first associated identifier;
the request to perform the slice switching registration implicitly indicates to tear down all protocol data unit (PDU) sessions associated with a currently registered associated identifier;
the at least one associated identifier being different from a default subscription permanent identifier (SUPI) associated with the UE;
each associated identifier includes at least one of:
   a SUPI for the isolated set of S-NSSAI; and/or
   at least one Global Public Subscriber Identifier (GPSI) per S-NSSAI in the set; and
each isolated set of S-NSSAI comprises one or more S-NSSAIs.

Embodiment D5. The AMF node of any one of Embodiments D1-D4, wherein the AMF node and/or the processing circuitry and/or the communication interface is further configured to cause the AMF node to one or more of:
retrieve at least one network slice specific authentication and authorization (NSSAA) Global Public Subscriber Identifier (GPSI) from a unified data management (UDM) node during a registration procedure of the UE to a network; and
send the at least one NSSAA-GPSI to the UE, each S-NSSAI that is subject to NSSAA being associated with a respective NSSAI-GPSI, the NSSAI-GPSI being a key to identify an extensible authentication protocol identity (EAP-ID) and associated security information stored at the UE.

Embodiment D6. The AMF node of Embodiment D5, wherein one or more of:
the NSSAA GPSI corresponds to at least one stored GPSI that is associated with an associated identifier; and/or
the NSSAA GPSI is indicated in the registration accept message or a UE configuration update message.

Embodiment E1. A method implemented in a unified data management (UDM) node, the method comprising:
receiving a request to retrieve subscription data for a user equipment (UE) during a registration procedure of the UE to a network; and
sending the subscription data to an access and mobility function (AMF) node as a result of the request, the subscription data comprising at least one associated identifier, each associated identifier being associated with a respective isolated set of single-network slice selection assistance information (S-NSSAI).

Embodiment E2. The method of Embodiment E1, wherein one or more of:
the UDM node is pre-configured with the at least one associated identifier corresponding to the UE;
the at least one associated identifier being different from a default subscription permanent identifier (SUPI) associated with the UE;
each associated identifier includes one or more of:
   a SUPI for the isolated set of S-NSSAI; and
   at least one Global Public Subscriber Identifier (GPSI) per S-NSSAI in the set; and/or
each isolated set of S-NSSAI comprises one or more S-NSSAIs.

Embodiment E3. The method of any one of Embodiments E1 and E2, further comprising:
providing at least one network slice specific authentication and authorization (NSSAA) Global Public Subscriber Identifier (GPSI) associated with a user equipment (UE), each S-NSSAI that is subject to NSSAA being associated with a respective NSSAI-GPSI, the NSSAI-GPSI being a key to identify an extensible authentication protocol identity (EAP-ID) and associated security information stored at the UE.

Embodiment E4. The method of Embodiment E3, wherein one or more of:
the NSSAA GPSI corresponds to at least one stored GPSI that is associated with an associated identifier;
the NSSAA GPSI is indicated in the retrieve subscription data; and/or
the at least one NSSAA GPSI is provided to an access and mobility function (AMF) node during a registration procedure of the UE to a network or a UE configuration update message.

Embodiment F1. A unified data management (UDM) node comprising processing circuitry and/or a communication interface, the UDM node and/or the processing circuitry and/or the communication interface configured to cause the UDM node to:
receive a request to retrieve subscription data for a user equipment (UE) during a registration procedure of the UE to a network; and
send the subscription data to an access and mobility function (AMF) node as a result of the request, the subscription data comprising at least one associated identifier, each associated identifier being associated with a respective isolated set of single-network slice selection assistance information (S-NSSAI).

Embodiment F2. The UDM node of Embodiment F1, wherein one or more of:
the UDM node is pre-configured with the at least one associated identifier corresponding to the UE;
the at least one associated identifier being different from a default subscription permanent identifier (SUPI) associated with the UE; each associated identifier includes one or more of:
   a SUPI for the isolated set of S-NSSAI; and
   at least one Global Public Subscriber Identifier (GPSI) per S-NSSAI in the set; and/or
each isolated set of S-NSSAI comprises one or more S-NSSAIs.

Embodiment F3. The UDM node of any one of Embodiments F1 and F2, wherein the UDM node and/or the processing circuitry and/or the communication interface is configured to cause the UDM node to:
provide at least one network slice specific authentication and authorization (NSSAA) Global Public Subscriber Identifier (GPSI) associated with a user equipment (UE), each S-NSSAI that is subject to NSSAA being associated with a respective NSSAI-GPSI, the NSSAI-GPSI being a key to identify an extensible authentication protocol identity (EAP-ID) and associated security information stored at the UE.

Embodiment F4. The UDM node of Embodiment F3, wherein one or more of:
the NSSAA GPSI corresponds to at least one stored GPSI that is associated with an associated identifier;
the NSSAA GPSI is indicated in the retrieve subscription data; and/or
the at least one NSSAA GPSI is provided to an access and mobility function (AMF) node during a registration procedure of the UE to a network or a UE configuration update message.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A user equipment, UE, configured with a first identifier and a second identifier, the UE comprising processing circuitry configured to:
determine that resources and data associated with the first identifier require end-to-end isolation from the resources and data associated with the second identifier;
cause transmission of a registration message to a network node comprising the first identifier; and
if the UE has existing connections associated with the second identifier, release the existing connections associated with the second identifier to provide end-to-end isolation of the resources and data when the first identifier is transmitted in the registration message.

2. The UE of claim 1, wherein the first identifier and the second identifier correspond to a first and a second slice identifier.

3. The UE of claim 1, wherein the first identifier and the second identifier correspond to a first and a second vertical identifier.

4. The UE of claim 1, wherein the first identifier and the second identifier correspond to a first and a second Subscription Permanent Identifier, SUPI, or Global Public Subscriber Identifier, GPSI.

5. The UE of claim 1, wherein the resources associated with the first identifier correspond to at least one of a first memory space, a first processing resource and a first network resource and the resources associated with the second identifier correspond to at least one of a second memory space, a second processing resource and a second network resource, the resources associated with the first identifier being isolated from the resources associated with the second identifier.

6.-14. (canceled)

15. A method implemented in a network node, the method comprising:
sending a first associated identifier and a second associated identifier to a user equipment, UE, the first associated identifier being associated with information identifying a first set of network slices that requires isolation and the second associated identifier being associated with information identifying a second set of network slices that requires isolation;
receiving a registration message comprising the first associated identifier from the UE; and
as a result of the received registration message, terminating all protocol data unit, PDU, sessions associated with the second associated identifier to provide the required isolation of the first set of network slices from at least the second set of network slices when the first associated identifier is comprised in the registration message.

16. The method of claim 15, wherein the information identifying the first set of network slices comprises a first set of network slice selection assistance information, NSSAI; and
the information identifying the second set of network slices comprises a second set of NSSAI.

17. The method of claim 15, wherein sending the first and second associated identifiers in one of a registration accept message and a UE configuration update message.

18. The method of claim 15, further comprising:
as a result of the received the registration message comprising the first associated identifier, performing a slice switching registration using the first associated identifier.

19. The method of claim 18, further comprising:
as a result of the slice switching registration, sending a second globally unique temporary identifier, 5G-GUTI, to the UE, the second 5G-GUTI overwriting a current 5G-GUTI at the UE.

20. The method of claim 18, wherein the slice switching registration comprises switching the UE from the second set of network slices to the first set of network slices that is associated with the first associated identifier comprised in the registration message.

21. The method of claim 15, wherein the first associated identifier in the registration message implicitly indicates to tear down all the PDU sessions associated with the second associated identifier.

22. The method of claim 15, wherein the first associated identifier comprises a subscription permanent identifier, SUPI, and a Global Public Subscriber Identifier, GPSI, per network slice in the first set of network slices.

23. The method of claim 22, further comprising:
sending security information and an extensible authentication protocol identity, EAP-ID, to the UE, the GPSI that is associated with the first network slice being a key for the UE to identify the security information and the EAP-ID to use in a network slice-specific authentication and authorization, NSSAA, procedure for the first network slice.

24. A method implemented in a unified data management, UDM, node, the method comprising:
receiving a request to retrieve subscription data for a user equipment, UE, during a registration procedure of the UE to a network; and
sending the subscription data to an access and mobility function, AMF, node as a result of the request, the subscription data comprising a first associated identifier and a second associated identifier, the first associated identifier being associated with information identifying a first set of network slices that requires isolation and the second associated identifier being associated with information identifying a second set of network slices that requires isolation.

25. The method of claim 24, wherein the first and second associated identifiers comprise a subscription permanent identifier, SUPI, and a Global Public Subscriber Identifier, GPSI, per network slice in the respective set of network slices.

26. The method of claim 25, further comprising:
sending security information and an extensible authentication protocol identity, EAP-ID, to the AMF node, the GPSI being a key for the UE to identify the security information and the EAP-ID to use in a network slice-specific authentication and authorization, NSSAA, procedure for a network slice that is associated with the GPSI.

27.-34. (canceled)
